(19) United States
(12) Patent Application Publication
(10) Pub. No.: US 2010/0065034 A1
(43) Pub. Date: Mar. 18, 2010

(54) FUEL CONVERSION ADAPTER FOR A BACKPACKING STOVE

(75) Inventor: Norris Richard Long, Wichita, KS (US)

Correspondence Address: The Coleman Company, 3600 North Hydraullic, IP Legal- 11702, WICHITA, KS, 67219, US

(73) Assignee: THE COLEMAN COMPANY, INC., Wichita, KS (US)

(21) Appl. No.: 12/162,287

(22) PCT Filed: Jan. 19, 2007
(86) PCT No.: PCT/US07/60781

§ 371 Date: Aug. 10, 2009

Related U.S. Application Data
(60) Provisional application No. 60/762,974, filed on Jan. 27, 2006.

(51) Int. Cl. F24C 5/20; A47J 37/00

(52) U.S. Cl. 126/38; 126/25 R

(57) ABSTRACT

A fuel conversion adapter (20) is provided that fits on a valve assembly for a stove or other burning appliance and permits the fuel conversion adapter to attach to a different fuel canister. A swiveling connector (32) is provided between a valve connector (28) and an engagement collar (34) so that the engagement collar may be properly aligned with a valve on the burner and the valve connector may be arranged as desired to align a fuel canister attached thereto.

### REFERENCE TO RELATED APPLICATION

This application claims priority to U.S. provisional patent application Ser. No. 60/762,974, filed Jan. 27, 2006, and is incorporated herein by reference.

### TECHNICAL FIELD OF THE INVENTION

The present invention relates to fuel burner appliances, and more specifically to backpacking and camping stoves.

### BACKGROUND OF THE INVENTION

Backpacking stoves come in various shapes and sizes. The key goals for a backpacking stove are that the backpacking stove be lightweight and that the backpacking stove provide sufficient power so as to boil water or cook other items in a backpacking environment.

The Coleman Company, Inc. sells a number of backpacking stoves that are used with its POWERMAX brand blend of fuels. These fuels are provided in a disposable cylinder, and include butane and propane in an efficient blend. POWERMAX fuel is a liquefied petroleum gas (LPG). LPG is generally utilized as a fuel or liquid which vaporizes at ambient pressures and temperatures, but which is stored in containers under pressure in liquid form. Most conventional burning appliances that utilize LPG are relatively simple, having a valve adapted to connect the pressurized LPG container to a burner.

The POWERMAX brand fuel canister, and its connection to a backpacking stove, is one of the embodiments described in U.S. Pat. No. 5,868,126. Although that patent may be consulted for a description of a POWERMAX canister, in general, the canister is a cylindrical aerosol-type vessel. The canister includes a hexagonal pedestal for attachment to a valve assembly for a backpacking stove that is made to be attached to such a pedestal.

Although the POWERMAX LPG containers work well for their intended purpose, these containers are not always available. For example, many general goods stores located along backpacking trails may not carry the POWERMAX brand LPG canisters.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a fuel conversion adapter is provided that fits on a valve assembly for a stove and permits the fuel conversion adapter to attach to standard butane/propane canisters. Such canisters typically have a threaded opening and are usually configured to attach to a stove having a “Lindel” valve.

In accordance with an embodiment, the fuel conversion adapter includes an engagement collar for attaching to a valve for a burner, and a connector for attaching to a fuel canister, such as a fuel canister configured for use with a Lindel valve. In an embodiment, the engagement collar is designed to fit onto a valve that typically receives a POWERMAX cylinder, although features of the present invention may be utilized with other configurations of valves.

In an embodiment, the valve connector is supported by feet on the fuel conversion adapter. A swiveling connector is provided between the valve connector and the engagement collar so that the engagement collar may be properly aligned with the valve on the burner and the valve connector may be arranged as desired to align a fuel canister attached thereto.

Other features of the invention will become apparent from the following detailed description when taken in conjunction with the drawings, in which:

### BRIEF DESCRIPTION OF THE DRAWINGS

FIG. 1 is a side perspective view of a fuel conversion adapter in accordance with an embodiment;

FIG. 2 is a front perspective view of the fuel conversion adapter of FIG. 1;

FIG. 3 is a side perspective view of a stationary collar for the fuel conversion adapter of FIG. 1;

FIG. 4 is a side perspective view of a rotating valve body for the fuel conversion adapter of FIG. 1;

FIG. 5 is a sectional view taken along the cut-away lines 5--5 of FIG. 3;

FIG. 6 is a sectional view taken along the cut-away lines 6--6 of FIGS. 3; and

FIG. 7 is a sectional view taken along the cut-away lines 7--7 of FIG. 4.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

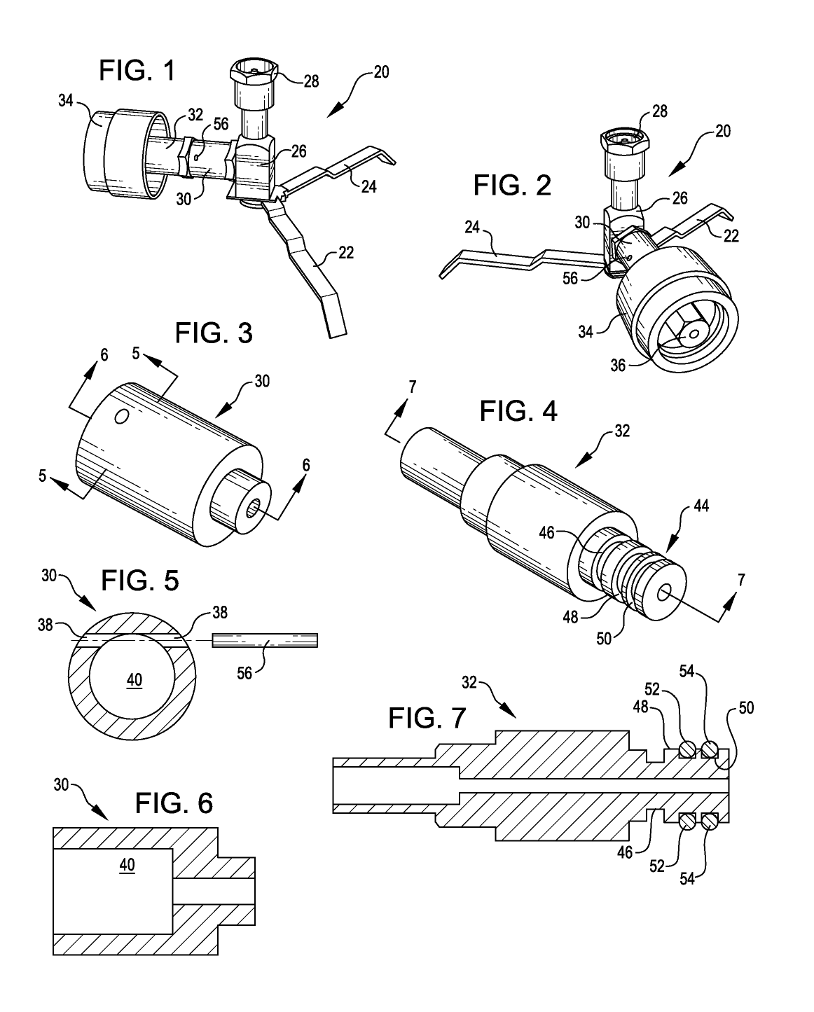

Referring now to the drawings, in which like reference numerals represent like parts throughout the several views, FIG. 1 shows a fuel conversion adapter 20 in accordance with an embodiment. The fuel conversion adapter 20 shown in the drawings includes two feet 22, 24. In the embodiment shown in the drawings, these feet are rotatably attached to an upright post 26 of the fuel conversion adapter 20. The feet 22, 24 may include stops to lock or position the feet in the outer positions shown in FIGS. 1 and 2. When the feet 22, 24 are in these positions, the post 26 is supported in an upright position. In addition, in accordance with an embodiment, the feet may be rotated underneath the body of the fuel conversion adapter 20 so that the fuel conversion adapter may be compactly stored.

The fuel conversion adapter 20 includes a valve connector 28 at the top of the upright post 26. In an embodiment, the valve connector 28 is a Lindel valve connector, although other valve connectors may be used. As is known, for a Lindel valve connector, a canister having a Lindel pedestal may be attached thereto. These canisters may be arranged so that they are attached with the canister upside down (i.e., the pedestal for the canister at the bottom of the canister). Thus, in the embodiment shown in FIG. 1, the legs 22, 24 help to stabilize a canister attached to the valve connector 24 in an upright manner, with the canister upside down.

A stationary collar 30 is attached to the upright post 26. A rotating valve body 32 is attached on the opposite side of the stationary collar 30. An engagement collar 34 is attached to the end of the rotating valve body 32.

The engagement collar 34 may be of a suitable configuration to attach to a burner. In an embodiment, the engagement collar 34 is arranged to attach to a valve connector such as is described in U.S. Pat. No. 5,868,126. Thus, in accordance with an embodiment, the engagement collar includes a hexagonal pedestal 36 (FIG. 2). However, other types of pedestals and/or engagement collars may be utilized. Appropriate valving and other internal structure are provided with the engagement collar, such as the structure described in U.S. Pat. No. 5,868,126.

In accordance with an embodiment, the rotating valve body 32 is arranged to rotate relative to the stationary collar 30, thus allowing the engagement collar 34 to be positioned to properly align with a valve of a burner. This feature is helpful because the valve arrangement of the burner may include a connector that is subject to alignment with a fuel canister, such as a hexagonal valve connector for receiving the hexagonal pedestal 36. Due to different possible stove arrangements and positioning of a stove, the hexagonal valve connector of the burner may be presented in a number of different ways, and if a rotating connection of the engagement collar 34 relative to the valve connector 28 is not provided, then the fuel conversion adapter 20 may be tilted in an unstable manner. In contrast, by providing a rotating connection between the post 26 and the engagement collar 34, the engagement collar may be properly aligned with the connector on a stove, and the post may be aligned in a desired orientation, e.g., upright.

Details of the stationary collar 30 are shown in FIGS. 5 and 6. As can be seen in FIG. 5, the stationary collar 30 includes a bore 38 that extends from one side of the stationary collar to an opposite side. The bore 38 extends through an inner cavity 40 of the stationary collar.

Details of the rotating valve body 32 can be seen in FIG. 7. The rotating valve body 32 includes a stem 44 having three grooves 46, 48, and 50. The two outer grooves 48, 50, are each configured to receive o-rings 52 and 54 (FIG. 7), respectively. The inner groove 46 is positioned inside of the outer grooves 48, 50. The function of the inner groove 46 is described below.

The stem 44 of the rotating valve body 32 is positioned within the inner cavity 40 of the stationary collar 30. The two o-rings 52, 54 provide a seal and prevent leakage of fuel or gaseous vapors out of the fuel conversion adapter 20. When the stem 44 is fully inserted into the stationary collar 30, a pin 56 (FIG. 5) is driven into the bore 38. This pin 56 extends through the inner groove 46. The pin prevents the stem 44 from being removed from the inner cavity 40 of the stationary collar. However, the groove 46, because it is annular groove, permits the pin 56 to travel within the groove when the rotating valve body 32 is rotated relative to the stationary collar 30. During this rotation, the two o-rings 52, 54 maintain a seal and prevent leakage of fuel or gaseous vapors out of the fuel conversion adapter 20.

As can be understood, the fuel conversion adapter 20 provides a convenient and sturdy adapter for permitting a user to attach a different type of canister to a burner. In addition, the swivel or rotating connection provided by the attachment of the rotating valve body 32 to the stationary collar 30 permits a canister attached to the valve connector 28 to be aligned as desired, and permits the engagement collar 34 to be properly aligned with a valve system of a burner.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel conversion adapter, comprising:
a first connector for connecting to a fuel canister;
a second connector for connecting to a burning appliance, the first connector and the second connector being different varieties; and
a rotating connector between the first connector and the second connector so that the second connector may be properly aligned with a suitable connector on the burning appliance and the first connector may be aligned for connection to a fuel canister.

2. The fuel conversion adapter of claim 1, further comprising a post fixed to first connector and the rotating connector.

3. The fuel conversion adapter of claim 2, further comprising feet connected to the post to support the post when a fuel canister is connected to the first connector.

4. The fuel conversion adapter of claim 3, wherein the feet are foldable under the rotating connector.

5. The fuel conversion adapter of claim 3, wherein the post, the first connector and the second connector are arranged so a central bore of the second connector extends substantially perpendicularly to a central bore of the first connector.

6. The fuel conversion adapter of claim 5, wherein the first connector is arranged to support a canister attached to the first connector in an upright position.

7. The fuel conversion adapter of claim 2, wherein the post, the first connector and the second connector are arranged so a central bore of the second connector extends substantially perpendicularly to a central bore of the first connector.

8. The fuel conversion adapter of claim 7, wherein the first connector is arranged to support a canister attached to the first connector in an upright position.

9. The fuel conversion adapter of claim 1, wherein the first connector and the second connector are arranged so a central bore of the second connector extends substantially perpendicularly to a central bore of the first connector.

10. The fuel conversion adapter of claim 9, wherein the first connector is arranged to support a canister attached to the first connector in an upright position.

11. The fuel conversion adapter of claim 1, wherein the first connector is arranged to support a canister attached to the first connector in an upright position.

12. The fuel conversion adapter of claim 1, further comprising feet connected to the first connector to support the first connector when a fuel canister is connected to the first connector.

13. The fuel conversion adapter of claim 12, wherein the feet and the first connector are arranged to support a canister attached to the first connector in an upright position.
